(19) United States
(12) Patent Application Publication
(10) Pub. No.: US 2021/0043879 A1
(43) Pub. Date: Feb. 11, 2021

(54) BATTERY

(71) Applicants: SANYO ELECTRIC CO., LTD., Osaka (JP); PANASONIC CORPORATION, Osaka (JP)

(72) Inventors: Shin HARAGUCHI, Hyogo (JP); Oose OKUTANI, Hyogo (JP); Shinya GESHI, Osaka (JP)

(21) Appl. No.: 17/045,271

(22) PCT Filed: Apr. 3, 2019
(86) PCT No.: PCT/JP2019/014814

§ 371 Date: Oct. 5, 2020

(30) Foreign Application Priority Data
Apr. 6, 2018 (JP) 2018-074198

(51) Int. Cl. H01M 2/02; H01M 2/08

(52) U.S. Cl. CPC H01M 2/024; H01M 2220/20; H01M 2/028; H01M 2/08

(57) ABSTRACT

A battery includes: a batter can having a cylindrical portion, a bottom wall closing one end of the cylindrical portion, and an open rim continuing to the other end of the cylindrical portion; an electrode body housed in the cylindrical portion; a sealing body fixed to the open rim so as to seal an opening defined by the open rim; and a electrically insulating film disposed on at least part of at least an inner wall of the battery can. The sealing body includes a sealing plate and a gasket disposed at a peripheral portion of the sealing plate. The insulating film has a first portion covering at least part of a first region of the inner wall corresponding to between an end of the gasket on the electrode body side and an end of the electrode body on the gasket side.

### TECHNICAL FIELD

The present invention relates to a battery including a battery can, an electrode body housed in the battery can, and a sealing body sealing the opening of the battery can.

### BACKGROUND ART

When sealing the opening of a battery can with a sealing body, typically, the battery can is constricted inward in the vicinity of the opening, so that an annular groove is formed therearound. The sealing body has a gasket provided at its peripheral portion. The gasket of the sealing body is disposed between the annular groove and the end of the battery can, and compressed vertically, and thereby the sealing body is fixed to the battery can (see Patent Literature 1).

### CITATION LIST

### Patent Literature

[PTL 1] Japanese Laid-Open Patent Publication No. H7-105933

### SUMMARY OF INVENTION

### Technical Problem

Batteries have been recently used in a vehicle, such as a car. Assuming an accident, it has been increasingly required for the batteries to cause no internal short circuit even when they are severely deformed or damaged. For example, in a crush test (flat-plate crush test) of a battery under severer conditions, there may be a case where severe deformation occurs in the inner wall of the battery can on the opening side and in the sealing plate, making the inner wall of the battery can including the above annular groove (also referred to as a constricted portion) come in contact with the sealing plate. Also, the inner wall of the battery can including the constricted portion may come in contact with the opening-side end of the electrode body housed in the battery can. Such a contact increases the risk of an internal short circuit.

### Solution to Problem

One aspect of the present invention relates to a battery including: a battery can having a cylindrical portion, a bottom wall closing one end of the cylindrical portion, and an open rim continuing to the other end of the cylindrical portion: an electrode body housed in the cylindrical portion; a sealing body fixed to the open rim so as to seal an opening defined by the open rim; and an electrically insulating film disposed on at least part of at least an inner wall of the battery can, the sealing body including a sealing plate and a gasket disposed at a peripheral portion of the sealing plate, the electrically insulating film has a first portion covering at least part of a first region of the inner wall corresponding to between an end of the gasket on the electrode body side and an end of the electrode body on the gasket side.

### Advantageous Effects of Invention

A battery in which an internal short circuit is unlikely to occur in a crush test (flat-plate crush test) can be provided. In the crush test, a pressure is applied with a flat plate to the battery in its width direction until it is deformed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A schematic vertical cross-sectional view of a battery according to a first embodiment of the present invention.

FIG. 2 An enlarged view of a region II of FIG. 1.

FIG. 3 A schematic cross-sectional view showing a battery can of FIG. 2.

FIG. 4 A schematic vertical cross-sectional view of a battery according to a second embodiment of the present invention.

FIG. 5 An oblique view of the battery of FIG. 4.

FIG. 6 An enlarged view of a region VI of FIG. 4.

FIG. 7 A schematic cross-sectional view showing a battery can of FIG. 6.

FIG. 8 An enlarged view of the same region as the region VI of FIG. 4 in a battery according to a third embodiment of the present invention.

FIG. 9 An enlarged view of the same region as the region VI of FIG. 4 in a battery according to a fourth embodiment of the present invention.

FIG. 10 An enlarged view of the same region as the region VI of FIG. 4 in a battery according to a fifth embodiment of the present invention.

FIG. 11 A schematic vertical cross-sectional view of an essential part of the battery of FIG. 4 including a cap.

FIG. 12 An oblique view (a) of the cap and a rear view (b) thereof, and an oblique view (c) of the battery including the cap.

FIG. 13 Explanatory diagrams of an example of a production method of the battery of FIG. 4 including a preparation step (A), a sealing step (B), and a lateral crimping step (C).

FIG. 14 An enlarged view of the same region as the region II of FIG. 1 in a battery of Comparative Example 1.

### DESCRIPTION OF EMBODIMENTS

A battery according to the present embodiment includes: a battery can having a cylindrical portion, a bottom wall closing one end of the cylindrical portion, and an open rim continuing to the other end of the cylindrical portion; an electrode body housed in the cylindrical portion; a sealing body fixed to the open rim so as to seal an opening defined by the open rim; and an electrically insulating film disposed on at least part of at least an inner wall of the battery can. The sealing body includes a sealing plate and a gasket disposed at a peripheral portion of the sealing plate. The insulating film has a first portion covering at least part of a first region of the inner wall corresponding to between an end of the gasket on the electrode body side and an end of the electrode body on the gasket side.

For lithium ion secondary batteries and other similar batteries, a crush test is performed as one of the test methods for evaluating battery safety. Among various crush tests, in a crush test (flat-plate crush test) in which a large force is applied with a flat plate to the battery in its width direction until it is deformed, significant deformation occurs in the inner wall of the open rim of the battery can and the metal member constituting the sealing body, such as the sealing plate. Due to the deformation, the inner wall of the battery tends to come in contact with the metal member of the sealing body and with an end of the electrode body on the open rim side (more specifically, an end surface on the open rim side (esp., a periphery of the end surface)). Therefore, in such a flat-plate crash test, the risk of internal short circuit remarkably increases. Especially in a region (the above first region) of the inner wall of the battery can corresponding to between the end of the gasket on the electrode body side and the end of the electrode body on the gasket side, the contact with the metal member of the sealing body and the end of the electrode body is likely to occur in a flat-plate crush test.

According to the present embodiment, as described above, an electrically insulating film having a first portion covering at least part of the first region is formed. Therefore, even when the battery can and the sealing body are deformed in a flat-plate crush test by application of a large pressure to the battery in its width direction, the contact of the first region of the inner wall of the battery can with the metal member of the sealing body and/or the end surface of the electrode body (e.g., a tab of the electrode) can be prevented. Thus, the occurrence of an internal short circuit in the battery in a flat-plate crush test can be suppressed. Note that when the battery is greatly deformed in a flat-plate crush test and the distance becomes extremely smaller between the inner wall of the battery can and the metal member of the sealing body, which have opposite polarities, a short circuit (liquid junction) may occur via electrolyte. According to the present embodiment, the occurrence of such a liquid junction can also be suppressed.

Here, the width direction of the battery is a direction perpendicular to the height direction of the battery (or the height direction of the battery can). For example, in a battery employing a wound electrode body, the width direction of the battery is a direction perpendicular to the winding axis.

In view of more effectively preventing the contact of the first region with the metal member of the sealing body or the end surface of the electrode body, for example, half or more of the first region (i.e., half or more of its area) is preferably covered with the first portion, and 60 area % or more, and further, 80 area % or more of the first region may be covered with the first portion.

The insulating film preferably further includes a second portion entirely covering a second region of the inner wall in the open rim the second region facing the gasket. The second portion is continuous with the first portion. By including the second portion, the occurrence of an internal short circuit of the battery in a flat-plate crush test can be more effectively suppressed, and the hermeticity (or hermetically sealed state) of the battery can be improved.

The insulating film may further include a third portion entirely covering a third region being an end surface of an endmost portion of the open rim of the battery can. The third portion is continuous with the second portion. The insulating film may further include a fourth portion covering at least part of a fourth region of an outer wall of the open rim of the battery can. The fourth portion is continuous with the third portion. The third region and the fourth region are usually prone to corrosion. However, by providing the third portion continuously with the second portion, and providing the fourth portion continuously with the third portion, the corrosion in the third region, the fourth region, and a vicinity thereof can be suppressed. Note that the fourth portion is not necessarily provided. When the fourth portion is not provided, electric current can be collected from the outer surface of the open rim, and this increases the flexibility in battery design.

The insulating film may further include a fifth portion covering at least part of a fifth region of the cylindrical portion, the fifth region facing a side surface of the electrode body. The fifth portion is continuous with the first portion. In this case, at least part of the side surface of the electrode body also faces the insulating film in the fifth portion. Therefore, even when the battery can or the sealing plate is deformed in a flat-plate crush test, an internal short circuit can be highly effectively suppressed. Note that the fifth portion is formed at least on an area in the fifth region, the area facing the end of the electrode body on the gasket side. When there is an area in the fifth region where the fifth portion is not formed, the area can be used to electrically connect the battery can to the electrode body therethrough, which makes it convenient to collect electric current.

The battery can may have a constricted portion interposed between the gasket and the electrode body. In a conventional typical battery, a constricted portion as above is formed when crimp-sealing the battery can. In the case of using a battery can having the constricted portion, in the present embodiment, the first portion may be formed on at least a surface of the constricted portion, the surface facing the periphery of the end of the electrode body (specifically, the end surface of the electrode body) on the gasket side. This can effectively suppress an inner short circuit that may occur in a flat-plate crush test when the periphery of the end of the electrode body on the gasket side comes in contact with the surface of the constricted portion facing this periphery.

The battery can may have no constricted portion interposed between the gasket and the electrode body. In a battery in which the battery can does not have such a constricted portion, the strength around the open rim is weak, and the electrode body is difficult to be held stably in the can. According to the present embodiment, however, since the insulating film as above is formed, even in a case where a battery can having no constructed portion is used, an internal short circuit can be highly effectively suppressed in a flat-plate crush test The first portion (and the fifth portion) is particularly effective in suppressing an internal short circuit in such a case.

The gasket may be compressed between an end surface of the peripheral portion of the sealing plate and the open rim, in the radial direction of the opening. Specifically, the open rim can have a pressing portion for pressing the gasket against the end surface of the peripheral portion of the sealing plate. The gasket is compressed by the pressing portion in the radial direction of the opening, and the repulsive force of the gasket acts to ensure the airtightness between the sealing body and the open rim.

In such a battery, the open rim of the battery can presses the gasket not in the axial direction (hereinafter, sometimes referred to as Z direction) of the battery can but in the direction perpendicular to the Z direction (hereinafter, sometimes referred to as XY direction). In this case, given that the pressing force of the open rim exerted on the gasket is decomposed in two directions: Z and XY, the scalar quantity of the vector in the XY direction is larger than that in the Z direction.

The open rim of the battery can may have a projection as at least part of the pressing portion, the projection protruding inward in the radial direction. In this case, the gasket is compressed in the radial direction at least by the projection. Such a projection can be formed by constricting the open rim inward. The projection may be formed intermittently in a plurality of numbers along the circumferential direction of the opening, or may be formed continuously along the circumferential direction of the opening. The continuously formed projection can form an annular groove along the circumferential direction of the opening. The projection(s) can press the gasket more strongly toward the end surface of the peripheral portion of the sealing plate. In this way, the airtightness between the sealing body and the open rim can be more reliably ensured.

The gasket may be of any shape, and has: for example, an inner ring portion disposed on the side facing the electrode body (the inner side) of the peripheral portion of the sealing plate; and aside wall portion covering an end surface of the peripheral portion of the sealing plate. In this case, the side wall portion is compressed in the radial direction. The gasket preferably further has an outer ring portion disposed on the outer side of the peripheral portion of the sealing plate. More specifically, the gasket preferably has an outer ring portion and an inner ring portion sandwiching the peripheral portion of the sealing plate therebetween, and a side wall portion covering the end surface of the peripheral portion of the sealing plate so as to connect the outer ring portion with the inner ring portion.

When the projection is formed intermittently in a plurality of numbers, the projections (at least two, preferably four or more projections) are provided preferably at equi-angular intervals with respect to the center of the opening.

In the height direction of the battery can, the projection is preferably substantially equal in position to the center of the end surface of the peripheral portion of the sealing plate. By aligning the position of the projection and the center position of the end surface flush with each other, the deformation of the sealing plate can be suppressed in forming the projection on the open rim of the battery. Moreover, the pressure applied to the gasket or its side wall portion is unlikely to be uneven. Accordingly, the deformation of the gasket tends to be suppressed, and the gasket can be compressed to a higher degree. This increases the airtightness inside the can.

Here, that the projection is substantially equal in position to the center of the end surface of the peripheral portion of the sealing plate means that, in the height direction of the battery can, the difference between the position of the projection and the center position of the end surface of the sealing plate is 2% or less of a height H of the battery can.

At the center position of the end surface of the peripheral portion of the sealing plate, a recessed groove may be formed so as to correspond to the projection provided on the open rim of the battery can. By providing the recessed groove, in forming the projection on the open rim of the batter, the deformation of the sealing plate can be more effectively suppressed, and the pressure applied to the gasket or its side wall portion is less likely to be uneven. The difference between the center position of the recessed groove and the position of the projection in the height direction of the battery can is 2% or less of the height H of the battery can.

In the height direction of the battery can, the open rim is made smaller in outer diameter at its lowermost position (the innermost position) in contact with the gasket or its inner ring portion, than the cylindrical portion. In this case, it is preferable to provide an annular cap which covers the gasket or its outer ring portion from the Z direction and covers the outer peripheral surface of the open rim of the battery can from the XY direction. The cap serves to protect the peripheral portion of the sealing plate and the open rim of the battery can. At this time, by joining the cap to the open rim, the sealing body can be more securely fixed to the battery can. The cap may be designed in such a thickness that the outer diameter of the cap becomes almost equal to the outer diameter of the cylindrical portion.

It is desirable that the sealing plate and the gasket are integrally molded by an insert molding technique or the like. According to the integral molding, the sealing plate and the gasket are easily welded to each other. By integrally molding the sealing plate and the gasket, the sealing body can be handled as one component, which can simplify the production of the battery.

According to the above configuration, it is not necessary to press the gasket in the Z direction for hermetically sealing the battery can. This eliminates the necessity of providing the battery can with a constricted portion interposed between the gasket or its inner ring portion and the electrode body. Therefore, the shortest distance between the sealing body and the electrode body can be decreased, and the energy density inside the can tends to be increased. Specifically, the shortest distance between the sealing body and the electrode body can be set to, for example, 2 mm or less, and preferably 1.5 mm or less.

Between the electrode body and the sealing body, generally, an electrically insulating plate may be disposed. Such an insulating plate is also called an upper insulating plate. The upper insulating plate can serve to suppress a short circuit between the electrode body and the sealing body or the lead, as well as to hold the electrode body stably in the battery can. The upper insulating plate is usually disposed between the constricted portion and the electrode body. When the battery can has no constricted portion, the upper insulating plate may or may not be disposed. Without the upper insulating plate, in a flat-plate crush test, an internal short circuit becomes more likely to occur because there is nothing to restrict the contact between the end surface of the electrode body and the inner wall of the battery can. Also, when subjected to vibration or drop impact, too, an internal short circuit is likely to occur due to the contact of the end surface of the electrode body with the inner wall of the battery. According to the present embodiment, since the insulating film as above is formed, even in a battery including no upper insulating plate, the occurrence of a short circuit between the inner wall of the battery can and the end surface of the electrode body or the metal member of the sealing body can be suppressed. When the gasket is compressed in the radial direction of the opening between the end surface of the peripheral portion and the open rim, the absence of the upper insulating plate leads, in particular, to a reduction in strength, increasing the risk of an internal short circuit in a flat-plate crush test. Even in this case, too, with the insulating film as above, an internal short circuit in a flat-plate crush test can be effectively suppressed.

A description will be given below of a battery according to an embodiment of the present invention with reference to the drawings. It is to be noted, however, the present invention is not limited thereto.

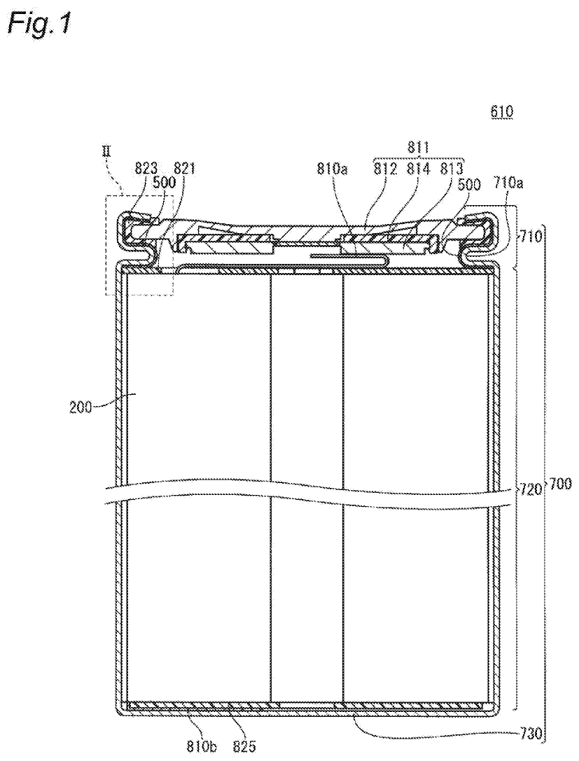

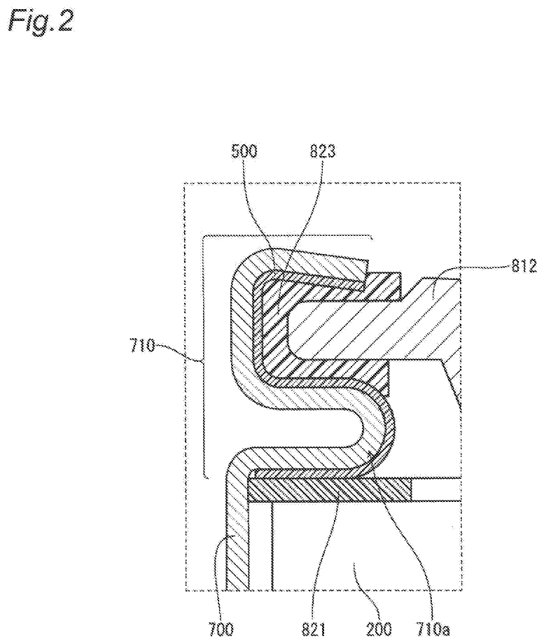

FIG. 1 is a schematic vertical cross-sectional view of a battery according to a first embodiment of the present invention. FIG. 2 is an enlarged view of a region II of FIG. 1. A battery 610 is cylindrical in shape, and includes a cylindrical bottomed battery can 700, a cylindrical electrode body 200 housed in the can, and a sealing body 811 sealing the opening of the battery can 700. The electrode body 200 is a wound electrode body formed by winding a positive electrode and a negative electrode, with a separator interposed therebetween. In the battery can 700, typically, an electrolyte (not shown) is housed, together with the electrode body 200.

The battery can 700 includes: a cylindrical portion 720 housing the electrode body 200; a bottom wall 730 closing one end of the cylindrical portion 720; and an open rim 710 continuing to the other end of the cylindrical portion 720. The opening defined by the open rim 710 is closed by the sealing body 811. An annular constricted portion 710a is formed in the vicinity of the open rim 710 of the battery can 700.

The sealing body 811 has a sealing plate 812, an internal terminal plate 813, and an annular electrically insulating member 814 disposed between an outer circumference portion of the sealing plate 812 and an outer circumference portion of the internal terminal plate 813. The sealing body 811 includes a gasket 823 provided at the peripheral portion, and seals the opening of the battery can 700 via the gasket 823. In the sealing body 811, the sealing plate 812 and the internal terminal plate 813 are connected to each other at their center portions. A positive electrode lead 810a extended from a positive electrode plate of the electrode body 200 is connected to the internal terminal plate 813. Thus, the sealing plate 812 functions as an external terminal of the positive electrode. A negative electrode lead 810b extended from a negative electrode plate of the electrode body 200 is connected to an inner surface of a bottom wall 730 of the battery can 700.

An electrically insulating plate (upper insulating plate) 821 is disposed between an end surface of the electrode body 200 on the gasket 823 side and the constricted portion 710a. An electrically insulating plate (lower insulating plate) 825 is disposed between an end surface of the electrode body 200 on the bottom wall 730 side and the bottom wall 730 of the battery can 700.

As illustrated in FIGS. 1 and 2, an electrically insulating film 500 is disposed on at least part of the inner wall of the battery can 700. Even when the battery can 700 or the internal terminal plate 813 is deformed in a flat-plate crush test, the insulating film 500 can prevent the battery can 700 from coming in contact with the internal terminal plate 813 and/or the end surface of the electrode body 200 on the gasket 823 side. Therefore, an internal short circuit can be suppressed.

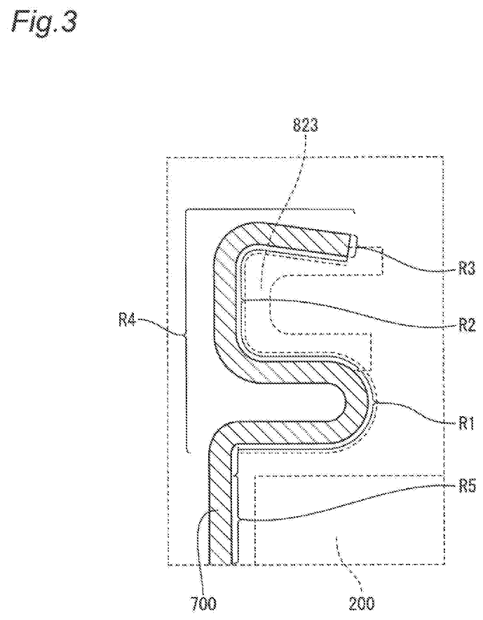

The position of the insulating film 500 will be specifically described with reference to FIG. 3. FIG. 3 is a schematic cross-sectional view showing the battery can 700 of FIG. 2. In FIG. 3, the gasket 823 and the electrode body 200 are shown by dotted lines. The battery can 700 includes a first region R1 corresponding to between an end of the gasket 823 on the electrode body 200 side and an end of the electrode body 200 on the gasket 823 side, and a second region R2 where the open rim 710 faces the gasket 823. The battery can 700 further includes a third region R3 which is an end surface of an endmost portion of the open rim 710, and a fourth region R4 of the outer wall (outer surface) of the open rim 710. The battery can 700 further includes a fifth region R5 of the cylindrical portion 720 facing the side surface of the electrode body 200. The insulating film 500 at least includes a first portion covering at least part of the first region R1. In the illustrated example of FIGS. 1 and 2, the insulating film 500 includes the first portion and a second portion covering the second region R2. The second portion is continuous with the first portion. By providing the insulating film 500 like this, an internal short-circuit can be effectively suppressed in a flat-plate crush test, and the hermeticity of the battery 610 can be ensured.

The insulating film 5X) may further include a third portion covering the third region R3, and may include a fourth portion covering the fourth region R4. The third portion is continuous with the second portion, and the fourth portion is continuous with the third portion. When the insulating film 500 has the third portion, or has the third portion and the fourth portion, the deterioration in the third region R3 and the fourth region R4 of the battery can 700 can be suppressed. The insulating film 500 may further include a fifth portion covering the fifth region R5. The fifth portion is continuous with the first portion. With the fifth portion, the contact of the inner wall of the battery can 700 with the electrode body 200 in a flat-plate crush test can be more effectively suppressed. Therefore, the internal short-circuit suppressing effect is further enhanced.

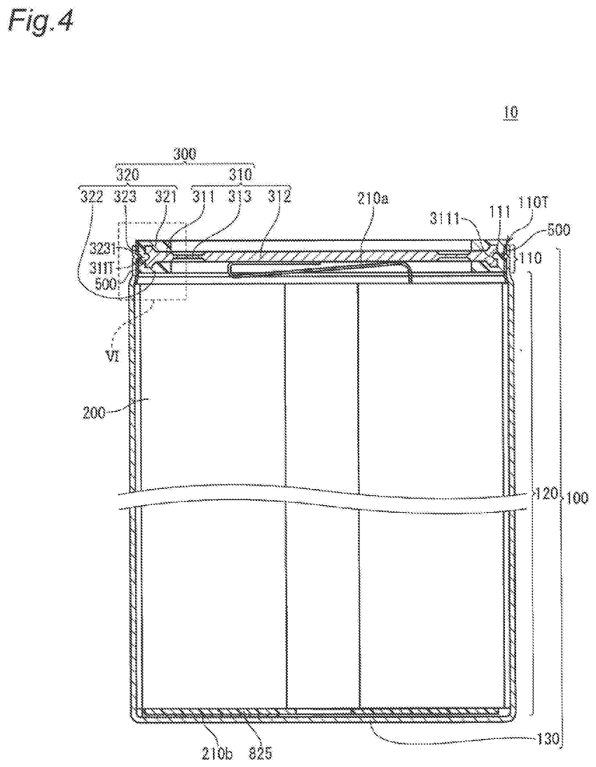

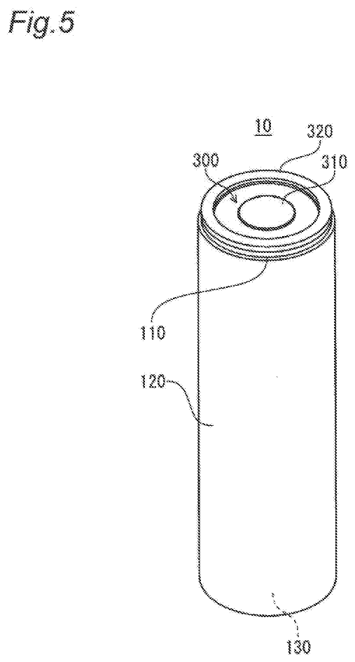

FIG. 4 is a schematic vertical cross-sectional view of a battery according to a second embodiment of the present invention. FIG. 5 is an oblique view of the battery. A battery 10 is cylindrical in shape, and includes a cylindrical bottomed battery can 100, the cylindrical (or columnar) electrode body 200 housed in the can, and a sealing body 300 sealing the opening of the battery can 100. In the battery can 100, usually, an electrolyte (not shown) is housed, together with the electrode body 200.

The battery can 100 includes a cylindrical portion 120 housing the electrode body 200, a bottom wall 130 closing one end of the cylindrical portion 120, and an open rim 110 continuing to the other end of the cylindrical portion 120. The opening defined by the open rim 110 is closed by the sealing body 300.

The sealing body 300 includes a sealing plate 310 and a gasket 320 disposed at a peripheral portion 311 of the sealing plate 310. The sealing plate 310 is disk-shaped and has an explosion-proof function. Specifically, the sealing plate 310 includes the peripheral portion 311 and a center region 312, both having a thick wall thickness and serving to provide structural strength, and a thin-walled portion 313 configured to exhibit an explosion-proof function. The thin-walled portion 313 is provided in an annular region between the peripheral portion 311 and the center region 312. To the inner surface of the center region 312, one end of a lead wire 210 extended from a positive electrode or a negative electrode constituting the electrode body 200 is connected. Thus, the sealing plate 310 functions as a terminal of one electrode. The lead wire 210 is electrically shielded from the electrode body with, for example, an insulating tape (not shown), in order to prevent an internal short circuit.

When the internal pressure of the battery can 100 increases, the sealing plate 310 bulges outward, and the stress due to tension is concentrated, for example, on the boundary between the peripheral portion 311 and the thin-walled portion 313, causing a break to occur from the boundary. As a result, the internal pressure of the battery can 100 is released, and the safety of the battery 10 can be ensured. Alternatively, the sealing body 300 comes off from the open rim 110 and the internal pressure is released.

The sealing plate 310 may be of any shape. In the illustrated example, the peripheral portion 311 is made thicker than the center region 312. The thick peripheral portion 311 can receive over a large area the pressure applied thereto from the open rim 110 of the battery can 100 in the radial direction of the opening, allowing the stress to be easily dispersed. A recessed groove 3111 is formed at the center position of an end surface 311T of the peripheral portion 311 so as to correspond to a projection 111 of the open rim 110.

The gasket 320 has an outer ring portion 321 and an inner ring portion 322, and a side wall portion 323 connecting the outer ring portion 321 with the inner ring portion 322. The end surface 311T of the peripheral portion 311 of the sealing plate 310 is covered with the side wall portion 323. The outer ring portion 321 and the inner ring portion 322 sandwich the peripheral portion 311 of the sealing plate 310 therebetween, and thereby the gasket 320 is secured to the sealing plate 310. The inner ring portion 322 also serves to prevent an internal short circuit due to a contact of the electrode body 200 with the sealing plate 310. Making the inner ring portion 322 larger in area can enhance its function to prevent the internal short circuit.

The outer ring portion 321, the inner ring portion 322, and the side wall portion 323 are formed as an integrally molded product. The gasket 320 can be integrally molded with the sealing plate 310, for example, by an insert molding technique.

To ensure the airtightness between the open rim 110 of the battery can 100 and the sealing body 300, it is necessary that at least part of the open rim 110 presses the side wall portion 323 of the gasket 320 against the end surface 311T of the peripheral portion 311 of the sealing plate 310, compressing the side wall portion 323 in the radial direction of the opening. Here, the projection 111 protruding inward is formed on the open rim 110 along the circumference of the opening, pressing the side wall portion 323 against the end surface 311T. The side wall portion 323 of the gasket 320 may be provided with a recessed portion 3231 in advance at a position corresponding to the projection 111. Providing the recessed portion 3231 on the gasket 320 can prevent the gasket 320 from being excessively deformed when the side wall 323 is compressed.

In the height direction of the battery can 100, the projection 111 is substantially equal in position to the center of the end surface 311T of the peripheral portion 311 of the sealing plate 310. By aligning the positions as above, the deformation of the sealing plate 310 and the gasket 320 can be suppressed, and the side wall portion 323 tends to be compressed to a higher degree. This can more reliably ensure the airtightness between the sealing body 300 and the open rim 110.

In the open rim 110 of the battery can 100, the endmost portion having the end surface 110T extends in the direction forming an angle of less than 5° with the axial direction (Z direction) of the battery can 100. This prevents the gasket 320 from being subjected to excessive stress, making it possible for the gasket 320 to ensure the airtightness more easily and reliably

The open rim 110 of the battery can 100 is made smaller in outer diameter than the cylindrical portion 120, at the lowest position of the open rim in contact with the inner ring portion 322 of the gasket 320, in the height direction of the battery can 100 of the battery 10. The outer ring portion 321 protrudes beyond the end surface 110T of the open rim 110 in the axial direction (Z direction) of the battery can 100. In such a case, it is preferable to provide a protective member so as to cover the open rim 110 of the battery can 100 and the outer ring portion 321 of the gasket 320.

In the battery 10, the battery can 100 does not have a constricted portion formed between the gasket 320 or the inner ring portion 322 and the electrode body 200. Therefore, the shortest distance between the sealing body 300 and the electrode body 200 can be reduced to, for example, 1 mm or less.

A negative electrode lead 210b extended from the negative electrode of the electrode body 200 is connected to the inner surface of the bottom wall 130 of the battery can 100. The electrically insulating plate (lower insulating plate) 825 is disposed between the end surface of the electrode body 200 on the bottom wall 130 side and the bottom wall 130 of the battery can 100.

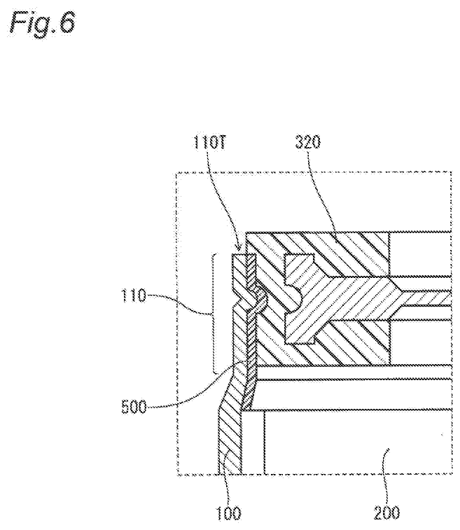

FIG. 6 is an enlarged view of a region VI of FIG. 4. As illustrated in FIGS. 4 and 6, the insulating film 500 is provided on at least part of the inner wall of the battery can 100. By providing the insulating film 500, as in the first embodiment, an internal short-circuit can be effectively suppressed in a flat-plate crush test.

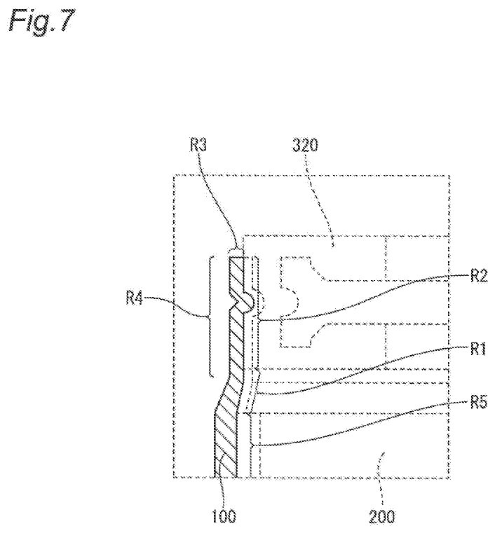

FIG. 7 is a schematic cross-sectional view showing the battery can 100 of FIG. 6. In FIG. 7, the gasket 320 and the electrode body 200 are shown by dotted lines. In FIG. 7, like in FIG. 3, the battery can 100 includes the first to fifth regions R1 to R5. In the illustrated example of FIGS. 4 and 6, the insulating film 500 includes the first portion and the second portion covering the second region R2. The second portion is continuous with the first portion. By providing the insulating film 500 like this, an internal short-circuit can be effectively suppressed in a flat-plate crush test, and the hermeticity of the battery 10 can be ensured.

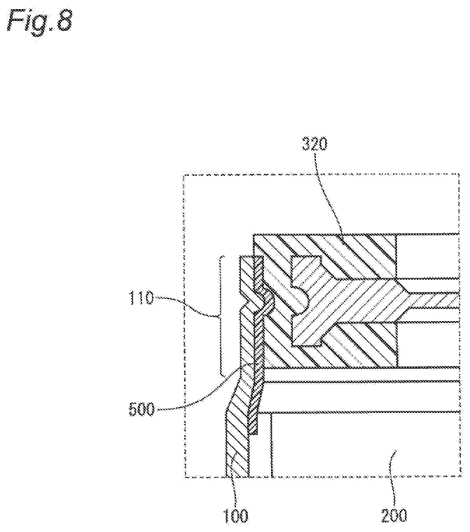

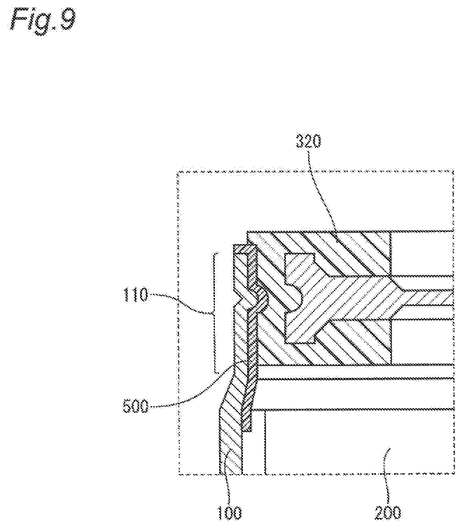

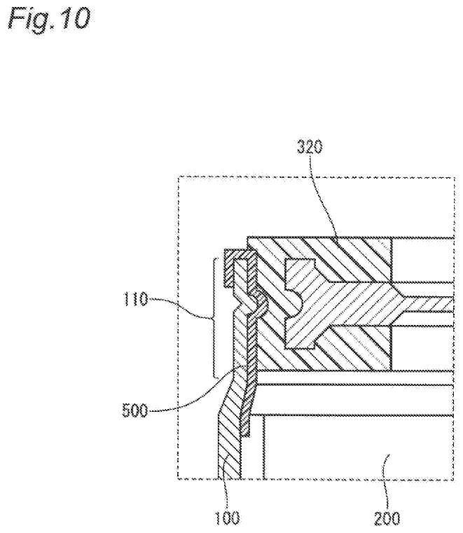

The insulating film 500 includes at least the first portion covering at least part of the first region R1. The insulating film 500 may further includes the third to fifth portions. FIGS. 8 to 10 are cross-sectional schematic views of a region corresponding to the region VI of FIG. 4 in batteries according to a third embodiment to a fifth embodiment of the present invention, respectively. In FIG. 8, the insulating film 500 includes, in addition to the first and the second portion, a fifth portion partially covering the fifth region R5 shown in FIG. 7. The fifth portion is continuous with the first portion. By providing the insulating film 500 like this, an internal short-circuit can be effectively suppressed in a flat-plate crush test, and the hermeticity of the battery 10 can be ensured. In FIG. 9, the insulating film 500 includes, in addition to the first, the second, and the fifth portion, a third portion covering the third region R3 shown in FIG. 7. The third portion is continuous with the second portion. In FIG. 10, the insulating film 500 includes, in addition to the first to third portions and the fifth portion, a fourth portion partially covering the fourth region R4 shown in FIG. 7. The fourth portion is continuous with the third portion. In the illustrated example, the fourth portion is formed on part of the fourth region near the third portion, but not limited thereto, and the fourth portion may be formed on the entire outer wall of the open rim 110. By providing the insulating film 500 including the third and the fourth portion, the corrosion of the open rim 110 can be suppressed.

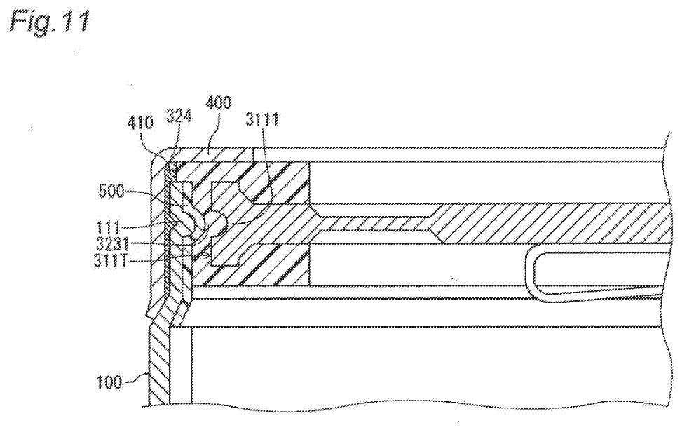

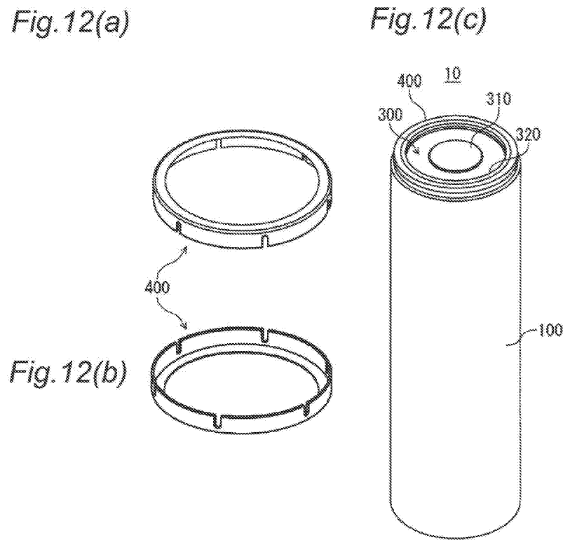

FIG. 11 is a schematic vertical cross-sectional view of an essential part of the battery 10 including a cap serving as a protective member. FIG. 12 is an oblique view (a) of the cap 400 and a rear view (b) thereof, and an oblique view (c) of the battery including the cap 400. The annular cap 400 covers the outer ring portion 321 of the gasket 320 from the Z direction, and covers the outer peripheral surface of the open rim 110 of the battery can 100 from the XY direction. The cap 400 is designed, for example, in such a thickness that the outer diameter of the cap 400 becomes substantially equal to the outer diameter of the cylindrical portion 120. A joining material 410 may be interposed between the cap 400 and the outer peripheral surface of the open rim 110. When the outer diameter of the cap 400 is substantially equal to that of the cylindrical portion 120, the difference between the outer diameter or the maximum outer diameter of the cap 400 and the outer diameter or the maximum outer diameter of the cylindrical portion 120 is, for example, 20% or less of an outer diameter D of the cylindrical portion 120.

When the cap 400 has electrical conductivity, the cap 400 can be configured to function as a terminal having a polarity different from that of the sealing plate 310. When the cap 400 is made function as a terminal, the other electrode having a polarity different from that of the sealing plate 310 is connected to the battery can 100. The cap 400 is joined to the open rim 110 by welding or the like. The cap 400 is an accessory, the shape of which can be flexibly designed according to use.

When the cap 400 with electrical conductivity is provided, the insulating film 500 is preferably not formed in the third region R3 and the fourth region R4.

The battery 610 can be produced by, for example, housing the electrode body 200 and an electrolyte in the cylindrical portion 720 of the battery can 700, placing the sealing body 811 with the gasket 823 attached at its periphery, inside the open rim 710, and crimp-sealing the sealing body 811 and the open rim 710 together. During the crimp-sealing process, a constricted portion 710a is formed. The insulating film 500 may be formed before the electrode body 200 and/or the electrolyte is housed in the battery can 700, or ma, be formed after at least one of them is housed. It should be noted, however, that the insulating film 500 is formed before placing the sealing body 811.

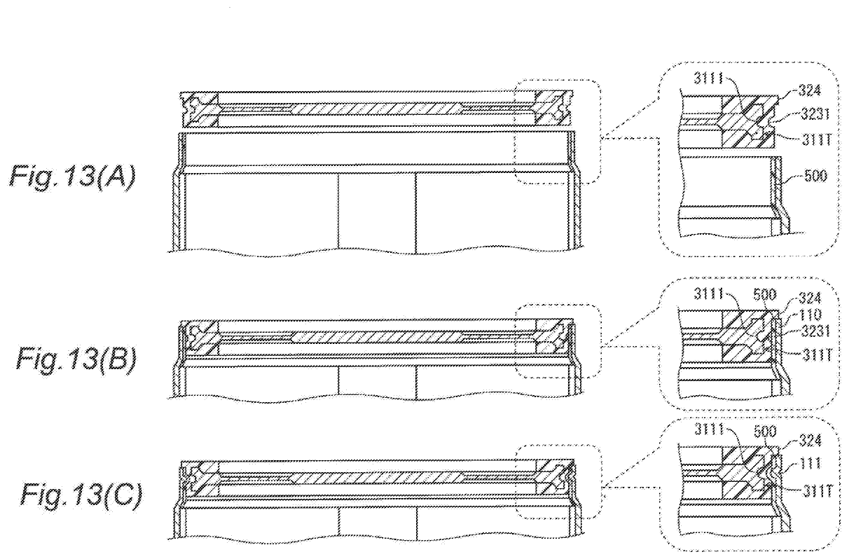

Next, a description will be given of an example of a production method of the battery 10, with reference to FIG. 13.

(1) Preparation Step

As illustrated in FIG. 13(A), the battery can 100 including the electrode body 200 housed in the cylindrical portion 120, and the sealing body 300 are prepared first. Before inserting the electrode body 200 into the can, the battery can 100 has an open rim 110 formed sufficiently larger in diameter than the electrode body 200. After the electrode body 200 is housed in the can, the open rim 110 is constricted radially, so that the outer diameter of the open rim 110 becomes smaller than that of the cylindrical portion 120.

In the battery 10, too, like in the battery 610, the insulating film 500 may be formed before the electrode body 200 and/or electrolyte is housed in the battery can 100, or may be formed after at least one of them is housed. It should be noted, however, that the insulating film 500 is formed before placing the sealing body 300.

The sealing body 300 can be prepared by insert-molding the gasket 320 together with the sealing plate 310. The thickness of the sealing plate 310 at the peripheral portion 311 is larger than that at the center region 312, and the peripheral portion 311 is provided with the recessed groove 3111 at the center position of the end surface 311T. Likewise, the gasket 320 is provided with the recessed portion 3231 at a position corresponding to the recessed groove 3111.

(2) Sealing Step

Next, as illustrated in FIG. 13(B), the sealing body 300 is placed inside the open rim 110 of the battery can 100. The sealing body 300 may be positioned in any way, but can be positioned by, for example, as illustrated in FIG. 13(B), using a protruding portion 324 provided at the upper end of the gasket 320 so as to protrude outward in the radial direction of the opening. The protruding portion 324 may be provided in a flange-like shape, or may be provided intermittently in a projection-like shape along the circumferential direction of the opening. Alternatively, a step portion may be provided on the inner side of the open rim 110 of the battery can 100, so that the sealing body 300 can be positioned at the step portion.

(3) Lateral Crimping Step

Next, as illustrated in FIG. 13(C), a grooving processing is applied to the open rim 110 of the battery can 100 so as to be recessed inward at a position corresponding to the recessed groove 3111 and the recessed portion 3231. The projection 111 protruding inward is thus formed on the open rim 110, so that the projection 111 presses the side wall portion 323 of the gasket 320 against the end surface 311T of the peripheral portion 311 of the sealing plate 310. As a result, the side wall portion 323 of the gasket 320 is compressed in the radial direction of the opening, and due to the repulsive force of the gasket 320, the airtightness between the sealing body 300 and the open rim 110 is ensured

Regardless of the structure of the battery, the insulating film 500 may be made of any material that has electrically insulating properties. As the material having insulating properties, for example, a commonly-used resin (e.g., electrically insulating resin) may be used. The resin is not limited, and may be a curable resin and/or a thermoplastic resin. The curable resin may be photocurable or thermosetting. Examples of the electrically insulating material include polyimide resin, polyamide resin, polyamide-imide resin, silicone resin, urethane resin, epoxy resin, phenol resin, acrylic resin, and/or a rubbery polymer. The curable resin contains, for example, a curable polymer (including a monomer, an oligomer, and/or a prepolymer), an initiator, a curing agent, and/or an additive.

The insulating film 500 is formed depending on the kind of the electrically insulating material. For example, the insulating film 500 may be formed by applying a curable resin onto at least the first region R1 (and, as necessary, onto at least one of the regions R2, R3, R4, and R5, in addition to the region R1), and curing the resin by application of light or heat. The curable resin applied onto at least the first region R1 may be semi-cured by application of light or heat, and in this state, sealing or crimping may be performed. During the sealing or crimping, the curing reaction ma be allowed to proceed until the resin is fully cured. As necessary, heat may be applied during or after sealing or crimping, to allow the curing reaction to further proceed. Alternatively, a thermoplastic resin dissolved in a solvent may be applied onto at least the first region R1, followed by volatilization of the solvent, thereby to form the insulating film 500. The solvent is selected depending on the type of the electrically insulating material. In the case of forming the insulating film 500 in the second region R2, by using a curable rein, and performing crimping after semi-curing the resin and then fully curing the resin after crimping, the airtightness of the battery 10 can be further enhanced.

The insulating film 500 is formed at least in the first region R1. In view of suppressing an internal short circuit that occurs in a flat-plate crush test, the insulating film 500 is preferably formed in the first and second regions R1 and R2, and preferably formed in the first, second, and fifth regions R1, R2, and R5. When formed in the first and second regions R1 and R2, the insulating film 500 is preferably formed so as to cover the entire second region R2 and at least part of the first region R1 on the second region R2 side (specifically, a half of the first region R1 on the second region R2 side). In the fifth region R5, the insulating film 500 (specifically, the fifth portion) is formed so as to face the end of the electrode body 200 on the gasket 823, 320 side. The width of the fifth portion (i.e., the length of the fifth portion in the direction parallel to the height of the battery can 700, 100) is, for example, 0.5 mm or more and 20 mm or less, and may be 1 mm or more and 10 mm or less, and may be 2 mm or more and 5 mm or less.

The thickness of the insulating film 500 is, for example, 0.5 μm or more and 50 μm or less, and may be 1 μm or more and 30 μm or less, and may be 10 μm or more and 30 μm or less. When the thickness is in the range above, an internal short-circuit in a flat-plate crush test can be more effectively suppressed. Moreover, the sealing can be performed with ease, and a high capacity tends to be secured.

The gasket 823, 320 may be made of any material. Examples of the material include polypropylene (PP), polyphenylene sulfide (PPS), polyether ether ketone (PEEK), polyethylene (PE), polybutylene terephthalate (PBT), perfluoroalkoxyalkane (PFA), polytetrafluoroethylene (PTFE), and polyamide (PA).

The gasket 823, 320 may be made of any material. Examples of the material include polypropylene (PP), polyphenylene sulfide (PPS), polyethylene (PE), polybutylene terephthalate (PBT), perfluoroalkoxyalkane (PFA), polytetrafluoroethylene (PTFE), and polyamide (PA).

Next, an illustrative description will be given of a configuration of the electrode body 200, with a lithium ion secondary battery taken as an example.

The cylindrical electrode body 200 is of a wound type, and is formed by spirally winding a positive electrode and a negative electrode with a separator interposed therebetween. To one of the positive and negative electrodes, the lead wire 210 is connected. The lead wire 210 is connected to the inner surface of the center region 312 of the sealing plate 310 by welding or the like. To the other one of the positive and negative electrodes, another lead wire is connected. The another lead wire is connected to the inner surface of the battery can 100 by welding or the like.

(Negative Electrode)

The negative electrode has a belt-like negative electrode current collector and a negative electrode active material layer formed on both sides of the negative electrode current collector. The negative electrode current collector is, for example, a metal film, a metal foil, or the like. The material of the negative electrode current collector is preferably at least one selected from the group consisting of copper; nickel, titanium, alloys thereof and stainless steel. The negative electrode current collector preferably has a thickness of, for example, 5 μm to 30 μm.

The negative electrode active material layer contains a negative electrode active material, and optionally contains a binder and an electrically conductive material. The negative electrode active material layer may be a deposition film formed by a gas phase method (e.g., vapor deposition). Examples of the negative electrode active material include Li metal, a metal or an alloy that electrochemically reacts with Li, a carbon material (e.g. graphite), a silicon alloy, a silicon oxide, and a metal oxide (e.g., lithium titanate). The negative electrode active material layer preferably has a thickness of, for example, 1 μm to 300 μm.

(Positive Electrode)

The positive electrode has a belt-like positive electrode current collector and a positive electrode active material layer formed on both sides of the positive electrode current collector. The positive electrode current collector is, for example, a metal film, a metal foil (stainless steel foil, aluminum foil, or aluminum alloy foil), or the like.

The positive electrode active material layer contains a positive electrode active material and a binder, and optionally contains an electrically conductive material. The positive electrode active material is not limited, but may be a lithium-containing composite oxide, such as LiCoO₂ or LiNiO₂. The positive electrode active material layer preferably has a thickness of for example, 1 μm to 300 μm.

Examples of the conductive material contained in each active material layer include graphite and carbon black. The conductive material is contained in an amount of for example, 0 to 20 parts by mass per 100 parts by mass of the active material. Examples of the binder contained in the active material layer include fluorocarbon resin, acrylic resin, and rubber particles. The binder is contained in an amount of, for example, 0.5 to 15 parts by mass per 100 parts by mass of the active material.

(Separator)

The separator is preferably a microporous resin film or a nonwoven resin fabric. Examples of the material (resin) of the separator include polyolefin, polyamide, and polyamide imide. The separator has a thickness of, for example, 8 μm to 30 μm.

(Electrolyte)

The electrolyte may be a non-aqueous solvent in ich a lithium salt is dissolved. Examples of the lithium salt include LiClO₄, LiBF₄, LiPF₆, LiCF₃SO₃, LiCF₃CO₂, and imide salts. Examples of the non-aqueous solvent include: cyclic carbonic esters, such as propylene carbonate, ethylene carbonate, and butylene carbonate: chain carbonic esters, such as diethyl carbonate, ethyl methyl carbonate, and dimethyl carbonate; and cyclic carboxylic acid esters, such as γ-butyrolactone and γ-valerolactone.

### EXAMPLES

The present invention will be more specifically described below with reference to Examples and Comparative Examples. It is to be noted, however, that the present invention is not limited to the following Examples.

### Example 1

A cylindrical lithium ion battery as illustrated in FIG. 1 was produced as follows.

### (1) Production of Positive Electrode Plate

First, 100 parts by weight of a positive electrode active material (LiNi_{0.8}Co_{0.15}Al_{0.05}O₂), 1.7 parts by mass of a binder (polyvinylidene fluoride), and 2.5 parts by mass of an electrically conductive agent (acetylene black) were added in a dispersion medium and kneaded together, to prepare a positive electrode mixture slurry. Then, the positive electrode mixture slurry was applied onto both surfaces of a positive electrode current collector made of aluminum foil, and dried and rolled into a positive electrode active material layer, followed by cutting them in a predetermined size, to obtain a positive electrode plate. The positive electrode current collector was partially exposed, and to the exposed portion, a positive electrode lead made of aluminum was connected.

### (2) Production of Negative Electrode Plate

First, 100 parts by mass of a negative electrode active material (graphite), 0.6 parts by mass of a binder (styrene-butadiene rubber), and 1 part by mass of a thickener (carboxymethyl cellulose) were added in a dispersion medium and kneaded together, to prepare a negative electrode mixture slurry. Then, the negative electrode mixture slurry was applied onto both surfaces of a negative electrode current collector made of copper foil, and dried and rolled into a negative electrode active material layer, followed by cutting them in a predetermined size, to obtain a negative electrode. The negative electrode current collector was partially exposed, and to the exposed portion, a negative electrode lead made of nickel was connected.

### (3) Preparation of Non-Aqueous Electrolyte

Ethylene carbonate (EC), dimethyl carbonate (DMC), and ethyl methyl carbonate (EMC) were mixed together, to prepare a non-aqueous solvent. To the non-aqueous solvent, LiPF₆ was dissolved at a concentration of 1 mol/L, to prepare a non-aqueous electrolyte.

### (4) Fabrication of Battery

The positive electrode plate and the negative electrode plate were wound, with a microporous membrane (separator) made of a polyolefin interposed therebetween, to form an electrode body.

An iron can with its inner and outer surfaces plated with nickel was used as the battery can 700. A xylene solution of a thermoplastic resin was applied onto the battery can 700 at portions to be the first region R1 and the second region R2, and heated at 60° C. to volatilize the xylene, into the insulating film 500. The electrode body was inserted, together with a lower insulating plate placed at the bottom of the electrode body, into the battery can 700, and a negative electrode lead was resistance-welded to the bottom of the battery can.

On the upper end surface of the electrode body, a disk-shaped upper insulating plate was placed. Next, a positive electrode lead was connected to a metal plate included in a sealing body having a safety mechanism. With a gasket attached to the periphery of the metal plate, the sealing body was set at the opening of the battery can. The open rim was crimped onto the periphery of the sealing body, thereby to complete a lithium ion secondary battery A1. In the battery A1, the insulating film 500 was formed at a position shown in FIGS. 1 and 2, that is, in the first and second regions R1 and R2.

### Comparative Example 1

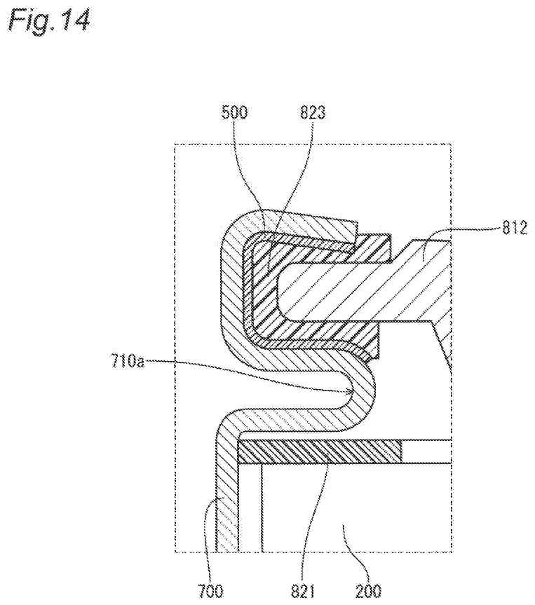

The insulating film 500 was formed at a position shown in FIG. 14, that is, only in the second region R2. A lithium ion battery B1 was fabricated in the same manner as in Example 1, except the above.

### [Evaluation]

The battery was charged until the SOC (State of charge) reached 30%, and the battery in this state was subjected to a flat-plate crush test as follows.

A stainless steel plate (length 40 cm×width 40 cm×thickness 3 cm) was collided onto the battery at its end on the sealing plate side, with a load of 20 kN at a speed of 30 mm/s, to apply a large force to the battery in its width direction, thereby to crush the battery. The surface temperature of the battery after crushing was measured to check whether heat generation had occurred or not. Five batteries each from the Example and Comparative Example batteries were tested.

With respect to the battery B1, heat generation had occurred in two out of five batteries. In contrast, with respect to the battery A1, the number of the batteries in which heat generation had occurred was zero out of five. The results show that the presence of the insulating film 500 in the first region R1 is significantly effective in suppressing an internal short circuit in the flat-plate crush test.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly it is intended that the appended claims be interpreted as covering all alterations and modifications as fall within the true spirit and scope of the invention.

### INDUSTRIAL APPLICABILITY

The battery according to the present invention is useful for non-aqueous electrolyte secondary batteries (esp., lithium ion secondary batteries) required to have a high energy density, and is suitably applicable as a power source for, for example, portable devices, hybrid vehicles, electric vehicles, and the like.

### REFERENCE SIGNS LIST

10, 610: battery, 100, 700: battery can, 110, 710: open rim, 110T: end surface, 111: projection, 120: cylindrical portion, 130, 730: bottom wall, 200: electrode body, 210a, 210b, 810a, 810b: lead, 300, 811: sealing body, 310, 812: sealing plate, 311: peripheral portion, 311T: end surface, 3111: recessed groove, 312: center region, 313: thin-walled portion, 320, 823: gasket, 321: outer ring portion, 322: inner ring portion 323: side wall portion, 3231: recessed portion, 324: protruding portion, 400: cap, 410: joining material, 500: insulating film, 710 a: constricted portion, 813: internal terminal plate, 814: insulating member, 821: upper insulating plate, 825: lower insulating plate, R1: first region, R2: second region, R3: third region, R4: fourth region, R5: fifth region

1. A battery comprising:
a battery can having a cylindrical portion, a bottom wall closing one end of the cylindrical portion, and an open rim continuing to the other end of the cylindrical portion; an electrode body housed in the cylindrical portion; a sealing body fixed to the open rim so as to seal an opening defined by the open rim; and an electrically insulating film disposed on at least part of at least an inner wall of the battery can,
the sealing body including a sealing plate and a gasket disposed at a peripheral portion of the sealing plate,
the electrically insulating film has a first portion covering at least part of a first region of the inner wall corresponding to between an end of the gasket on the electrode body side and an end of the electrode body on the gasket side.

2. The battery according to claim 1, wherein 80 area % or more of the first region is covered with the first portion.

3. The battery according to claim 1, wherein
the electrically insulating film further includes a second portion entirely covering a second region of the inner wall in the open rim, the second region facing the gasket; and
the second portion is continuous with the first portion.

4. The battery according to claim 3, wherein
the electrically insulating film further includes a third portion entirely covering a third region being an end surface of an endmost portion of the open rim of the battery can; and
the third portion is continuous with the second portion.

5. The battery according to claim 4, wherein
the electrically insulating film further includes a fourth portion covering at least part of a fourth region of an outer wall of the open rim of the battery can; and
the fourth portion is continuous with the third portion.

6. The battery according to claim 1, wherein
the electrically insulating film further includes a fifth portion covering at least part of a fifth region of the cylindrical portion, the fifth region facing a side surface of the electrode body; and
the fifth portion is continuous with the first portion.

7. The battery according to claim 1, wherein:
the battery can has a constricted portion interposed between the gasket and the electrode body; and
the first portion is formed at least on a surface of the constricted portion, the surface facing a periphery of the end of the electrode body on the gasket side.

8. The battery according to claim 1, wherein the battery can has no constricted portion interposed between the gasket and the electrode body.

9. The battery according to claim 1, wherein the gasket is compressed in a radial direction of the opening, between an end surface of the peripheral portion and the open rim.

10. The battery according to claim 9, wherein
the open rim has a projection protruding inward in the radial direction, and the gasket is compressed in the radial direction by the projection.

11. The battery according to claim 9, wherein no insulating plate is disposed between the electrode body and the sealing body.

12. The battery according to claim 9, wherein in a height direction of the battery can, the open rim is smaller in outer diameter at a lowermost position in contact with the gasket, than the cylindrical portion.
